(19) United States
(12) Patent Application Publication
(10) Pub. No.: US 2011/0159730 A1
(43) Pub. Date: Jun. 30, 2011

(54) SOFT HEAD STRUCTURE IN THE DECORATION LAMP STRING

(76) Inventor: DE-HUI LIN, Zhubei City (TW)

(21) Appl. No.: 12/650,568

(22) Filed: Dec. 31, 2009

(51) Int. Cl. H01R 13/40

(52) U.S. Cl. 439/602

(57) ABSTRACT

The present invention is to provide an improvement of soft head structure in the decoration lamp string. It mainly is that the soft head is set with two groove rails on the upper and lower wall surfaces of accommodating grooves for laying the conductive wires, and the conductive copper plates in conductive wires are put in the accommodating grooves by a vertical way from the groove rails and snap-clip on the linking grooves of accommodating grooves. Therefore, the combining of conductive wires and soft head can be suitable to be operated through the automatic machinery.

### BACKGROUND OF THE INVENTION

A structural form of soft head and conductive wire in the ordinary decoration lamp string is shown in FIGS. 1 and 2, wherein the soft head 10 is set with an accommodating groove 11 for establishing the conductive wire 20. The linking grooves 12 for snap-clipping and establishing a snap-clip part 31 in the conductive copper plate 30 of a conductive wire 20 are formed in the left and right sides of accommodating groove 11's front end, and the linking method of soft head 10 and conductive wire 20 is shown in FIG. 3. Due to that the height of snap-clip part 31 in the conductive copper plate 30 of conductive wire 20 is larger than the height of accommodating groove 11 but smaller than its width, the conductive copper plate 30 requires to be put in the accommodating groove 11 from its end in a horizontal status. After passing through the accommodating groove 11, the conductive copper plate 30 is turned to a vertical shape then leaned against the side. Finally, the conductive wire 20 is pulled to let the snap-clip part 31 of conductive copper plate 30 be put on the linking groove 12.

Due to that a conductive copper plate 30 of conductive wire 20 in the known structure requires to be put in the accommodating groove 11 in a horizontal status then turned to the vertical shape, it can then be snap-laid on the linking groove 12. Therefore, it requires to finish the connect-setting of one conductive wire 20 first then put in another conductive wire 20 for proceeding the clip-linking. Also, this way of assembling requires to be processed manually and is not suitable to be operated by automatic machinery. It thus requires more work and consumes more time, and its manufacturing cost is also increased relatively. It really is not very ideal and waited to be improved.

### OBJECT OF THE INVENTION

The present invention is to provide an improvement of soft head structure in the decoration lamp string. It mainly is that the soft head is set with two groove rails on the upper and lower wall surfaces of accommodating grooves for laying the conductive wires. It is able to have the conductive copper plates in two conductive wires simultaneously put in the accommodating grooves by a vertical way from the groove rails at one time and snap-clip on the linking grooves of accommodating grooves such that the assembling work of conductive wires and soft head can be completed through the operation of automatic machinery to let the assembly work of conductive wires and soft head become more rapidly and precisely. And, the object of largely reducing the manufacturing cost is thus achieved.

### BRIEF DESCRIPTION OF THE DRAWINGS

FIGS. 1 and 2 are diagrams of the match-setting forms of known soft head structures and conductive wires.

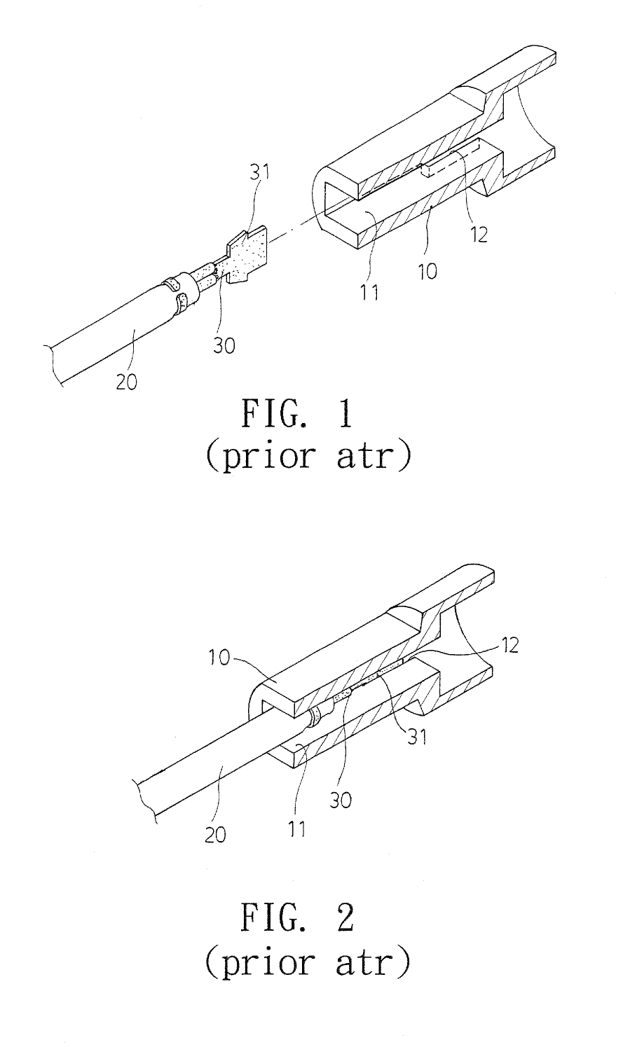

FIG. 3 is a diagram of linking method in the known soft head structures and conductive wires.

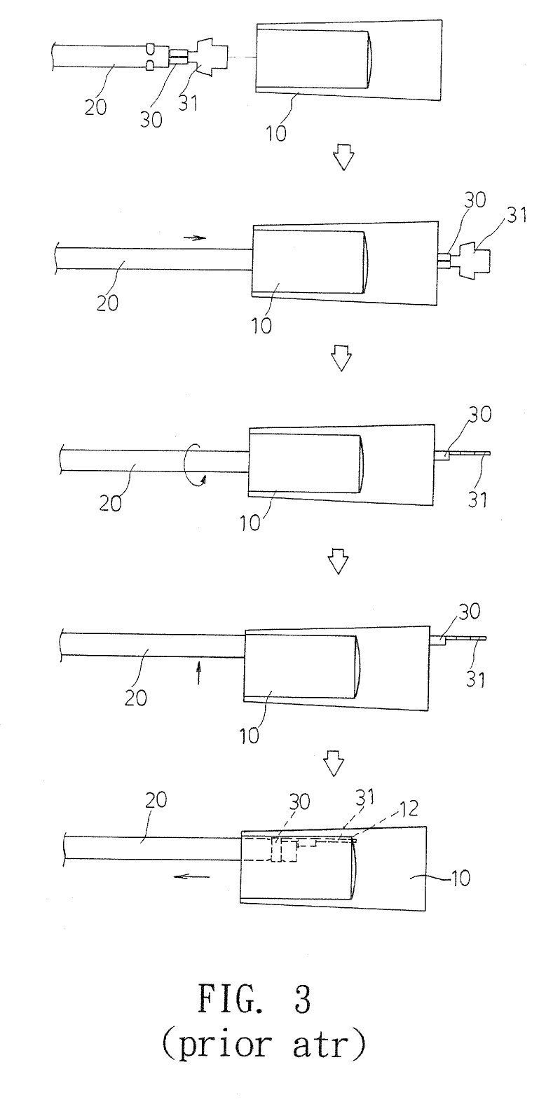

FIGS. 4 to 6 are diagrams of the match-setting forms of soft head structures and conductive wires in the present invention.

FIG. 7 is a diagram of linking method in the soft head structures and conductive wires of present invention.

### DETAILED DESCRIPTION OF THE DRAWINGS

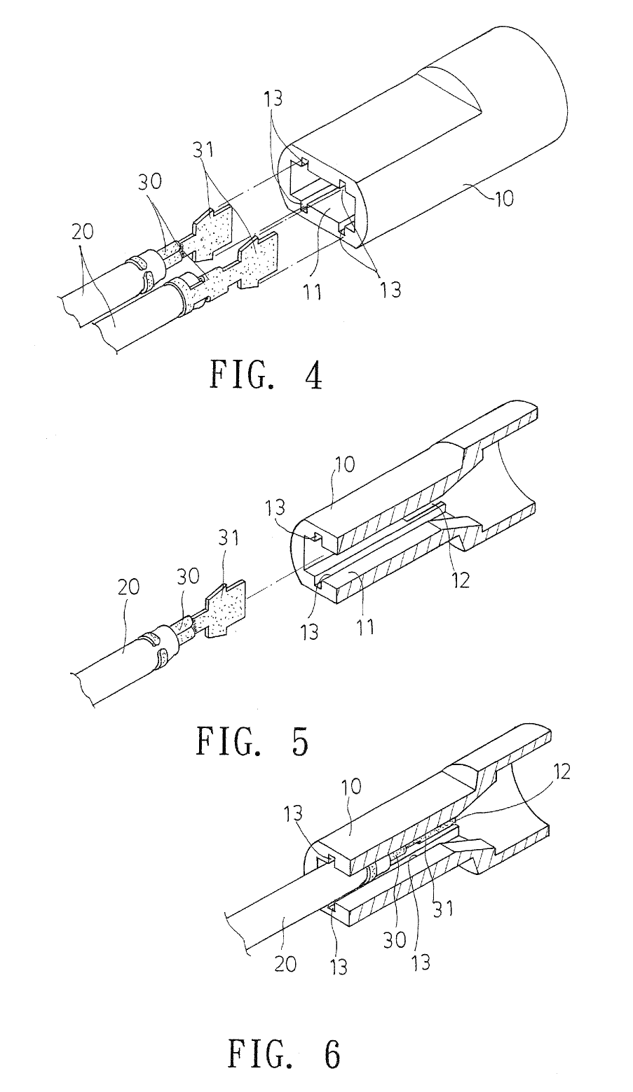

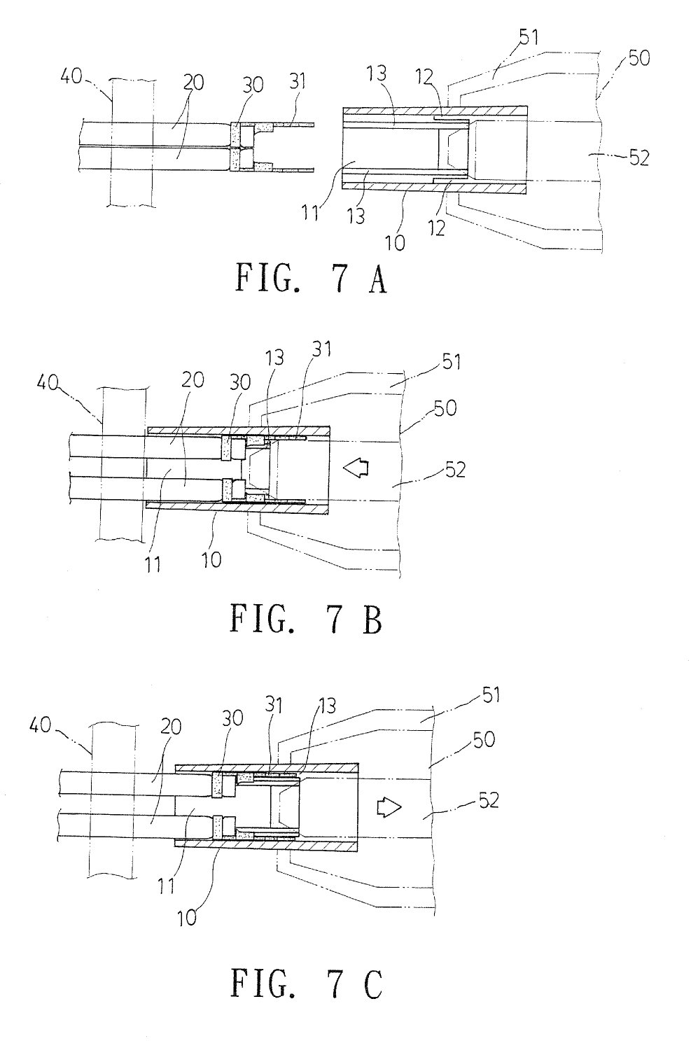

The present invention aims to make an improvement for the assemble-linking structure of soft head and conductive wire in the decoration lamp string. Please refer to those shown in FIGS. 4 and 6 which mainly is to set groove rails 13 separately on the upper and lower wall surfaces near to the sites of left and right groove walls on the accommodating grooves 11 of soft head 10 to let the height formed by the upper and lower groove rails 13 and linking grooves 12 slightly larger the height of copper plate 30 in the conductive wire 20, and the upper portions of groove rails 13 and the left right linking grooves 12 inside the accommodating 11 form a close neighbor status. Please cooperate to those shown in FIGS. 7A to 7C. The implementing method of present invention is to adopt the automatic machinery operation for the assemble-linking of soft head 10 and conductive wires 20, wherein the conductive wires 20 is operate-controlled by a positioning machine 20 and the soft head 10 is operate-controlled by a clamp-holding machine 50 with clamping claws 51 and brace-moving rod 52. After the positioning machine 40 positions two conductive wires 20 in a vertical shape, the wires are delivered simultaneously to the soft head 10 site clamped by clamp-holding machine 50. The soft head 10 is shifted toward two conductive wires 20 by the clamp-holding machine 50 to let the snap-clip parts 31 of copper plates 30 on two conductive wires 20 be separately put in the accommodating grooves 11 of soft head 10 from the left right two groove rails 13.

When the snap-clip parts 31 of two conductive plates 30 are passing through the accommodating grooves 11, they are simultaneously touching against with the brace-moving rod 52 of clamp-holding machine 50 and staying close to the left right wall surfaces. The clamp-holding machine 50 immediately shifts the soft head 10 backward slightly to let the snap-clip parts 31 of two conductive plates 30 separately be put in the linking grooves 12 and form a snap-clip. The assembling work of two conductive wires 20 and soft head 10 is thus completed.

According to the aforementioned implementing operations, it will be realized that the specific structure designed to improve by the present invention can let the assembly work of conductive wires and soft head become more rapidly and precisely through the operation of automatic machinery and achieve the effect of largely reducing the manufacturing cost. Therefore, the present invention obviously fulfills the conditions for approving the patent. We thus file the application according the law.

1. (canceled)

2. A bulb socket of decorative light string, the socket forming an accommodation chamber for accommodating electrical wires, the accommodation chamber having an inner end of which opposite side walls respectively form left-side and right-side retention slots for receiving and retaining retention tabs of conductive plates of the electrical wires, the improvement wherein the accommodation chamber of the socket forms, in top and bottom walls thereof at locations close to the left-side and right-side retention slots, channels that are flush with the retention slots at inner end, so that the channels are respectively and closely adjacent to the retention slots.
